(19) United States
(12) Patent Application Publication
(10) Pub. No.: US 2003/0229753 A1
(43) Pub. Date: Dec. 11, 2003

(54) Flash memory file system

(75) Inventor: Ho-sung Hwang, Anyang-si (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/254,541

(22) Filed: Sep. 26, 2002

(30) Foreign Application Priority Data
Jun. 10, 2002 (KR) 2002-32337

(51) Int. Cl. G06F 12/00

(52) U.S. Cl. 711/103; 711/156

(57) ABSTRACT

Provided is a file system for effectively using a flash memory. The file system includes a meta block for storing various file information, a data block where data is really stored, and an info block for storing information on the data block. Unlike the conventional method, the file system is designed not to allow one file to use a particular memory region, therefore it prevents a particular block in the flash memory from wearing at a faster rate than the other blocks. Further, the file system provides an effect of wear leveling of all blocks in the flash memory by using the entire memory region uniformly.

### BACKGROUND OF THE INVENTION

1. Field of the Invention

The present invention relates to a flash memory file system, and more particularly, to a file system for using a flash memory more efficiently by employing the entire block of the memory instead of a particular block of the memory according to the characteristics of the flash memory. The present application is based on Korean Patent Application No. 2002-32337, filed Jun. 10, 2002, which is incorporated herein by reference.

2. Description of the Related Art

A non-volatile memory is a memory in which information is retained even though power supply is severed. The following are different types of non-volatile memories: Read Only Memory (ROM), Erasable Programmable Read Only Memory (EPROM), Electrically Erasable Programmable Read Only Memory (EEPROM), flash memory and Ferro-electric Random Access Memory (FRAM).

From the above described memories, the flash memory is generally employed in an embedded device due to its high stability, large capacity, and cost-effectiveness. However, the flash memory has characteristics different from general memories such as RAM, and limits in usage.

A general flash memory file system comprises a logical address storage block which stores logical addresses capable of discriminating a particular file, a physical block in which data is really stored, and a map which stores relations between the blocks. If an application receives a request for file operations, the file system decides a logical address and approaches the physical block via the map.

However, in a conventional file system configured as above, an operation of correcting or updating information in a file is performed based on an erase unit. In other words, the flash memory contains a multiple erase unit of 128 KB. If a write is performed in a cell of the flash memory, it is required that the entire erase unit to which the cell belongs is deleted first and write is performed again in the cell. The non-volatile memory requires an erase cycle to update information which is already stored.

Wear of the flash memory is determined by the erase cycle and the flash memory ends its wear after about 100,000 write and erase cycles are performed in a cell. Accordingly, in order to utilize the flash memory effectively, it is required that the delete command should be equally performed in the entire flash memory.

Therefore, when information in a particular memory cell is repetitively read and written in a conventional file system, wear of the particular cell makes the cell wear out faster than other cells, therefore the use of the flash memory becomes impossible. In addition, it may lose the information in a file if loss of supply of power for most embedded devices using the flash memory occurs in the middle of the operations (delete and rewrite). Therefore, a method for distributing a region occupied by one file to the entire flash memory in order to assure uniform wear for each cell of the memory is needed. In addition, there is a need for a method for updating data lost during a power loss in the system using the memory.

### SUMMARY OF THE INVENTION

To solve the above described problems, it is an object of the present invention to provide a file system which uses efficiently a flash memory according to the characteristics of the flash memory.

It is another object of the present invention to provide a garbage collection method in which a flash memory is separated into three logical cells and data is updated using a block replacement method for wear leveling of all blocks of the flash memory.

To achieve the above objects of the present invention, there is provided a method for storing files in a flash memory, the method comprising; (a) receiving a file name, contents of the file which will be stored in the flash memory and a file storing command which will be stored in the flash memory; (b) outputting file management information which is used in managing the input file, and allocating meta blocks for storing the file management information; (c) storing the file management information in the allocated meta block; (d) allocating an info block which corresponds to the meta block, the info block for storing data block management information for managing the data block wherein the input contents of the file is stored; and (e) storing the input contents of the file in the data block corresponding to the info block.

To achieve the above objects of the present invention, there is provided a method for reading files in a flash memory, the method comprising: (a) receiving file management information including file name information of the files read from the files stored in a flash memory; (b) searching a meta block where file management information on the stored files is recorded using the file names, and an info block containing file management information on the stored files in connection with the position information on the data block where data is stored, and detecting file management information on files to be read and position information on the data block where data of the file to be read is stored; and (c) outputting data of the file to be read from the data block corresponding to the position information.

To achieve the above objects of the present invention, there is provided a method for replacing blocks in a flash file system, the method comprising: (a) receiving a name and contents of a file to be corrected along with a command for correcting the contents of the file; (b) allocating a meta block where file name information on an input file, file size information, file logical addresses information, information on whether a meta block is in use, and information indicating if the meta block is invalid, a data block where the contents of a file are actually stored, and an info block where position information on the data block is stored; (c) recording the information which the meta block corresponding to the received file name is invalid, and the information for the data block corresponding to the meta block is invalid; and (d) storing contents and management information on input files in newly allocated meta block, data block, and info block.

To achieve the above objects of the present invention, there is provided a method for garbage collection in a flash file system, the method comprising: (a) reading and storing the contents of a currently used meta block and a data block in a temporary storing place if there exist no more meta blocks and data blocks to be allocated, while a meta block for storing file name information on a file to be stored, file size information, file logic address information, information of whether a meta block is in use or not, and information that the meta block is invalid, and a data block where the contents of a file are to be actually stored is stored; (b) deleting invalid contents in the meta block and the data block by reading an info block having information that a meta block is invalid and a data block is no longer effective; and (c) reading data stored in the temporary storing place and rewriting the data in the deleted meta block and the deleted data block.

To achieve the above objects of the present invention, there is provided a flash file system management device comprising: a block searching unit for searching a meta block containing file name information on a file to be stored, file size information, file logical addresses information, information on whether a meta block is in use, and information indicating if a meta block is invalid, and for searching a data block where the contents of a file are to be really stored; a block allocation unit for searching and allocating a meta block and a data block which can be used according to the searching results of the searching unit, the searched and allocated meta block corresponding to an info block which stores information of the searched data block; a reading function performer for searching a meta block where file name information to be read in the searching unit is stored, reading an info block corresponding to the meta block, and reading the contents from a physical block where data is really stored; a writing function performer for performing write operations of a file to be stored in the meta block, the info block and the data block allocated by the block allocation unit; a block replacement function performer for exchanging the meta block and the data block where the contents of a file to be corrected are written with a new meta block and a new data block in a case that a file correction command is performed in the write function performer; and a garbage collection performer for deleting all invalid contents of the meta block, the data block, and info block, if a new meta block and a data block do not exist any more when the new meta block, the data block and info block need to be allocated by the block allocation unit.

To achieve the above objects of the present invention, there is provided a flash file system data structure comprising: a meta block for storing file management information which is information for managing files recorded in a flash memory; an info block which corresponds to the file management information and stores management information on a block where the contents of a file are stored; and a data block which corresponds to the management information stored in the info block and stores the contents of the file.

### BRIEF DESCRIPTION OF THE DRAWINGS

The above object and advantages of the present invention will become more apparent by describing in detail preferred embodiments thereof with reference to the attached drawings in which:

FIG. 1 is a configuration view of a general flash file system;

FIG. 2 is a flow chart of a method for updating files in a general file system;

FIG. 3 is a configuration view of a flash file system of the present invention;

FIG. 4 is a view showing a method of a block allocation;

FIG. 5 is a view showing a read process;

FIG. 6 is a view showing a write process;

FIG. 7 is a view showing a process of a block replacement;

FIG. 8 is a view showing a process of a garbage collection;

FIG. 9 is a configuration view of a management device of a flash file system according to the present invention.

### DETAILED DESCRIPTION OF THE INVENTION

The present invention will now be described more fully with reference to the accompanying drawings, in which the preferred embodiments of the invention are shown.

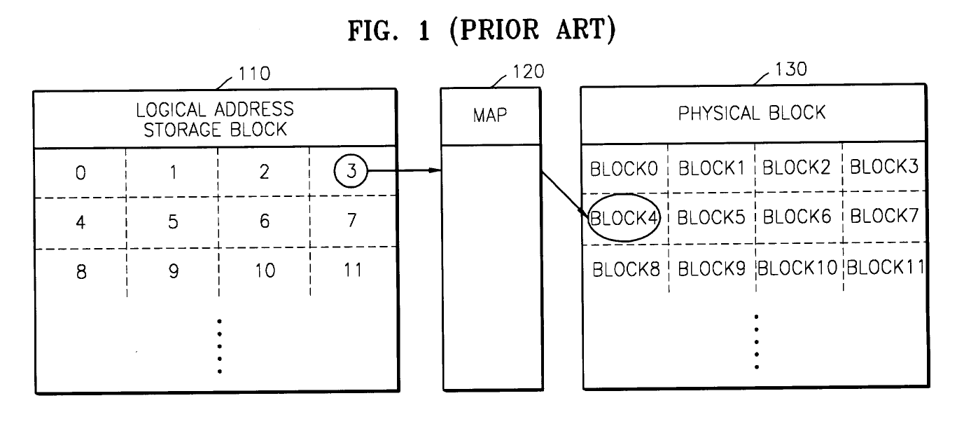

FIG. 1 is a configuration view of a general flash file system. The general file system comprises a logical address storing block 110 in which a logical address for discriminating a particular file is stored, a physical block 130 in which data is really stored, and a map 120 for storing relations between the blocks. If an application program receives a request for file operations, a file system decides a logic address of a file and approaches the physical block 130 via the map 120. The request for file operations includes reading, writing, and updating.

The flash memory needs to perform operations which are not required in updating a general hard-disk drive. First, the entire content of an erase unit where a particular file is stored is read in, because the flash memory can be erased only in the unit of an erase unit. Next, a particular file is updated, and the entire erase unit is erased before the data to be updated is rewritten. Then, the data to be updated is written in the erase unit.

Because the logical addresses shown in FIG. 1 contain meta data such as sizes of files which is also stored in the flash memory, updating the file and meta data should be performed in the above mentioned method.

In order to correct a file which is positioned at a particular position in the flash memory, it is required to erase an entire erase unit positioned in the flash memory occupied by a particular file. Therefore, the entire data contained in an erase unit including a cell to be corrected is read in and stored, and then the entire erase unit is erased and overwritten with the corrected contents.

Accordingly, in the conventional method, if a cell to be occupied by a file is determined, the cell is not changed and only the contents of the cell are changed. If a file is repeatedly corrected in a particular cell, the cell is subjected to greater wear than other cells, and thus stability problems occur in the entire region. In addition, information in the file may be lost due to an unexpected power loss.

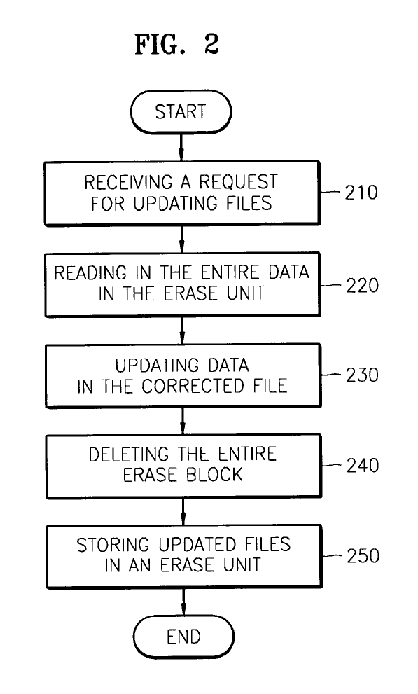

FIG. 2 is a flow chart of a method for updating files in a general file system. First, if a request for file updating is received is step 210, the entire data in the erase unit where a file is stored is read in step 220. Next, a corrected portion of the read-in data is updated in step 230. Before writing the updated file, the entire data of the erase unit 240 should be erased in step 240. Finally, the updated file is stored in the erase unit 250.

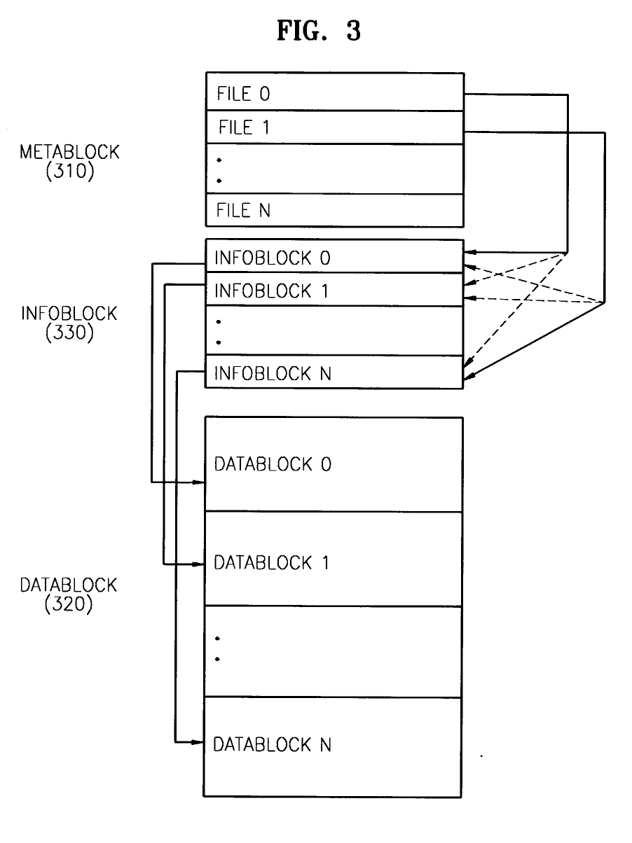

FIG. 3 is a configuration view of a flash file system of the present invention. The file system comprises a meta block 310 for storing various information on a file, a data block 320 for storing data, and an info block 330 for storing information on the data block.

The data block 320 is separated into particular sub blocks and information on each block is stored in corresponding sub blocks of the info block 330. The data block 320 comprises a flash memory divided into logical partitions with a particular size. The meta block 310 contains a file name, the file size, the file logical address, information that a meta block is in use or information that the meta block is invalid.

The info block 330 contains information on each data block divided into one size. The information includes information on position, information that the data block is in use or information that the data block is invalid.

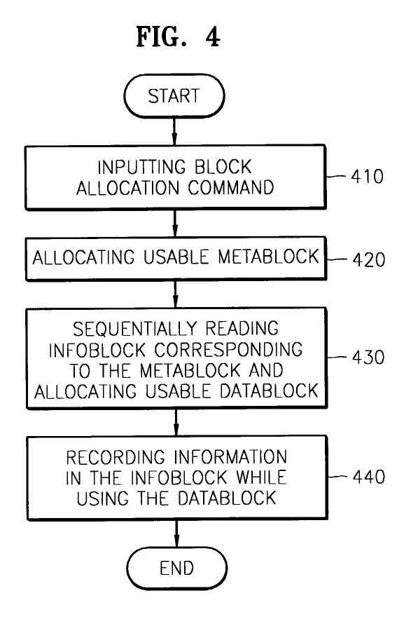

FIG. 4 is a view showing a method of a block allocation. The block allocation is performed as follows. The file system has a role of connecting a file, which is a logical object, with a physical implementation. If a block allocation command is received in step 410, a meta block where information on a file is stored is allocated in step 420. The meta block 310 stores information on a file name, the file size, the logical address, information that the meta block is in use or information that the meta block is invalid. Accordingly, if the information that the meta block is in use is read, it is possible to determine if a particular meta block can be used. Thus, the meta block can be allocated.

Next, a data block 430 where the contents of the file will be stored is allocated. Since information on the data block is managed in the info block, a usable data block is searched by sequentially scanning info blocks. Since the info blocks contain information on a position of the data block, information on whether the data block is in use or not, it is possible to indicate that a particular data block is used or not by reading the corresponding information.

After the meta block and the data block are allocated, information that the meta block, and that the data block are in use are respectively recorded in the data block and the info block in step 440.

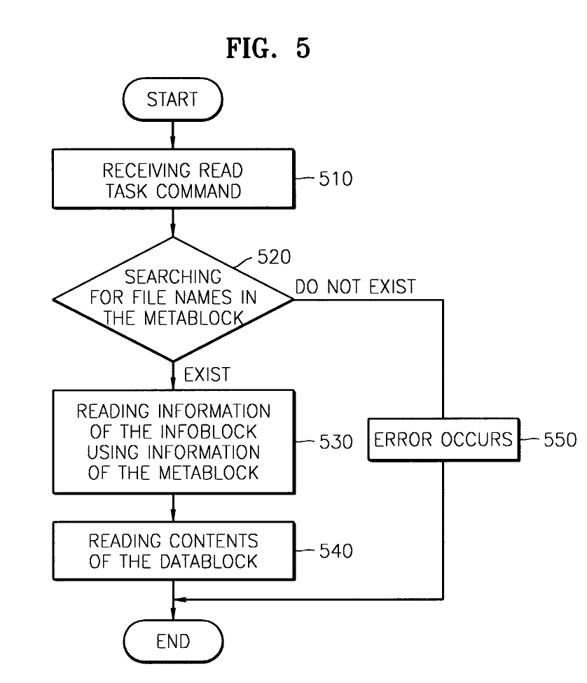

FIG. 5 is a view showing a process of reading. When a request for a read operation is received in step 510 from an application, a file name is searched in the meta block 520. If the file name does not exist in the meta block, an error occurs in step 550. If the file name exists, the information on the info block about the position of the data block where the file to be read is stored, is read in step 530 using the information in the meta block, and the contents of the data block where the file really exists is read in step 540.

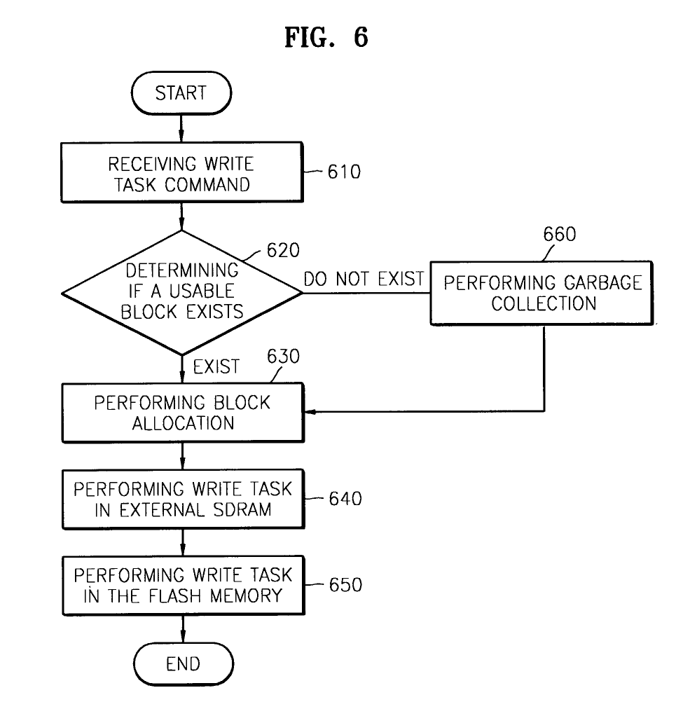

FIG. 6 is a view showing a process of writing. When a request for a write process is received from the application in step 610, it is determined first in step 610 if a usable meta block or a data block exists or not. If a usable meta block and a data block exists, the above-described block allocation is performed in step 630. If a usable meta block or a data block does not exist, a garbage collection is performed in step 660. Here, a meta block and a data block are allocated for a requested file, and the write operation is performed.

The write operation is not performed directly in the flash memory. The write operation is performed in step 640 in an external SDRAM, and after it is completed, the write operation is performed in step 650 in the flash memory. If the size of the file to be written is larger than the size of one data block, the write operation is performed in the flash memory in one block and the remaining portion is written in the SDRAM. After the write operation is completed in the SDRAM, the write operation is again performed in the flash memory.

If a request for a write operation of an already existing file, not for a new file, is received, in other words, an overwrite operation is required, a block replacement is performed as follows.

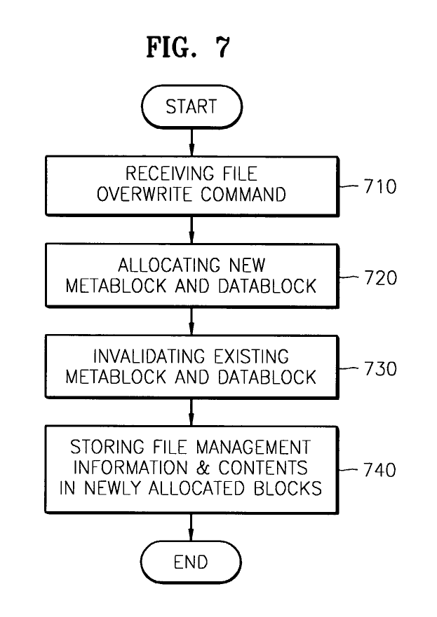

FIG. 7 is a view showing a process for a block replacement. If a request for a write operation of an already existing file is received, a block replacement is performed depending on whether the write operation is just a file exchange such as an overwriting or the write operation is just appending information to the existing file.

In the case of overwriting in step 710, the already existing meta block and the data block are replaced with a new meta block and new data block. The new meta block and new data block are allocated in step 720 using the above-mentioned block allocation method. The existing meta block and the data block containing files to be overwritten are invalidated in step 730. Finally, contents of a file and file management information input to the newly allocated meta block, the data block, and the info block are stored in step 740.

In a conventional method, it is required to remove an entire erase unit where particular data is positioned so as to correct the existing data due to the characteristics of the flash memory. This causes different cells of the flash memory to have different wear levels, due to repetitive erase and write cycles executed every time the existing information is corrected. But the present invention allocates a new meta block and a new data block. Therefore, the use of newly allocated blocks allow a delete command to be performed equally in all the cells of the flash memory.

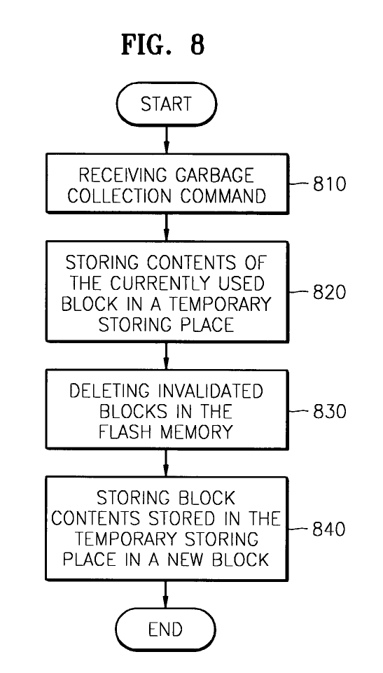

FIG. 8 is a view showing a process for data garbage collection. If a new meta block and a new data block are allocated, and a usable meta block and data block left is not available, a data garbage collection is performed. When the garbage collection command is received in step 810, the contents of the meta block and the data block in use are first moved into a temporary storing place in step 820, the contents of the meta block and the data block which are no longer valid in the flash memory are erased in step 830, and available data stored in the temporary storing place is written in step 840 in the flash memory.

If the garbage collection is performed, the contents in the meta block, and the info block should be changed to reflect the changed data block values.

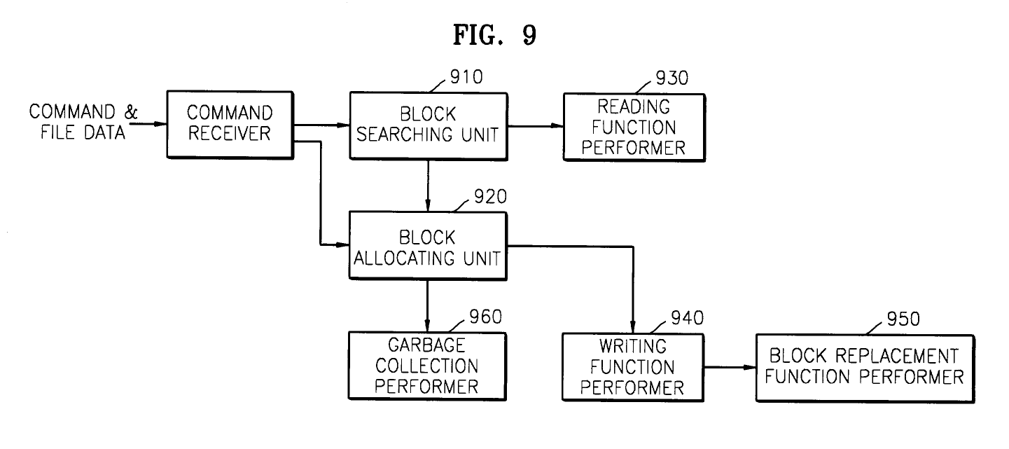

FIG. 9 is a configuration view of a device for managing a flash file system according to the present invention. A block searching unit 910 searches meta blocks which contain file name information of a file to be stored, file size information, file logical address information, information on whether a file is in use or not, and information indicating if the meta block is invalid, and a data block where the contents of a file are to be actually stored.

The block allocation unit 920 searches the meta block which can be used depending on the searching results in the block searching unit 910, allocates a meta block which can be further used, and allocates a data block by reading position information on the data block corresponding to the meta block.

After the search of a meta block wherein the file name information to be read is stored in the block searching unit 910, the read function performer 930 reads the contents of the data block in which data is actually stored.

The write function performer 940 performs a write operation of a file to be stored in the meta block and the data block which was allocated in the block allocation unit 920.

The block replacement function performer 950 changes the already existing meta block and the data block with a new meta block land a new data block in performing a function of overwriting files.

If the garbage collection performer 960 allocates a new meta block and a new data block in the block allocation unit 920, and effective meta blocks and data blocks do not exist, the contents of the meta block and the data block should be erased.

The above-mentioned preferred embodiments can be written as computer-programs, and can be embodied in a general digital computer or a recording medium. The recording medium includes storage materials such as a magnetic storage medium (for example, ROM, floppy disk, hard disk etc.), an optical reading material (for example, CD-ROM, DVD, etc.) and a carrier wave (for example, transmission via the Internet).

While this invention has been particularly shown and described with reference to the preferred embodiments thereof, it will be understood by those skilled in the art that various changes in form and details may be made therein without departing from the spirit and scope of the invention as defined by the appended claims.

This invention may, however, be embodied in many different forms and should not be construed as being limited to the embodiments set forth herein; rather, these embodiments are provided so that this disclosure will be thorough and complete and will fully convey the concept of the present invention to those skilled in the art.

As described above, unlike the conventional method, the present invention is designed not to allow one file to use a particular flash memory region, and thus can prevent wear in a particular block from accumulating faster than in other blocks in the flash memory, and thereby provides an effect of wear levelling in all the blocks of the flash memory by equally using the entire memory.

What is claimed is:

1. A method for storing files in a flash memory, the method comprising;
(a) receiving a file name of an input file, contents of the input file which will be stored in the flash memory and a file storing command which will be stored in the flash memory;
(b) outputting file management information used in managing the input file, and allocating a meta block for storing the file management information;
(c) storing the file management information in the allocated meta block;
(d) allocating an info block which corresponds to the allocated meta block, the info block for storing data block management information for managing the data block wherein the input contents of the file are stored; and
(e) storing the input contents of the input file in the data block corresponding to the info block.

2. The method for storing a file in a flash memory of claim 1, wherein the file management information comprises file name information of a stored file, file size information, file logical addresses information, information on whether a meta block is in use, and information indicating if a meta block is invalid.

3. The method for storing a file in a flash memory of claim 1, wherein the data block management information includes information indicating if a data block containing contents of a file is in use or not, and information indicating if the data block is invalid.

4. The method for storing a file in a flash memory of claim 1, wherein step (b) further comprises allocating usable meta blocks by sequentially reading file management information of a plurality of meta blocks of the flash memory and storing the newly produced file management information.

5. The method for storing a file in a flash memory of claim 1, wherein step (b) further comprises performing a garbage collection if there is no usable meta block.

6. The method for storing a file in a flash memory of claim 1, wherein step (c) further comprises reading a plurality of info blocks in the flash memory, searching a usable data block, reading the position information of the searched data block and storing the data in the corresponding data block.

7. The method for storing a file in a flash memory of claim 1, wherein step (d) further comprises storing a file to be written in an SDRAM and performing a write operation in the data block after the storing operation has been completed.

8. A method for reading files in a flash memory, the method comprising:
(a) receiving file management information including file name information of the files read from files stored in a flash memory;
(b) searching a meta block where file management information on the stored files is recorded using the file names, and an info block containing file management information on the stored files in connection with position information on the data block where data is stored, and detecting file management information on a file to be read and position information on the data block where data of the file to be read is stored; and
(c) outputting data of the file to be read from the data block corresponding to the position information.

9. The method for reading files in a flash memory of claim 8, wherein step (b) further comprises outputting an error message that a file name to be read does not exist, if a file name to be read is not found in the meta block.

10. A method for replacing blocks in a flash file system, the method comprising:
(a) receiving a name and contents of a file to be corrected along with a command for correcting the contents of the file;
(b) allocating a meta block where file name information on an input file, file size information, file logical address information, information on whether a meta block is in use, and information indicating if the meta block is invalid, a data block where the contents of a file is to be actually stored, and an info block where position information on the data block is stored;
(c) recording the information indicating that the meta block corresponding to the received file name is invalid, and the information indicating that the data block corresponding to the meta block is invalid; and
(d) storing contents and management information on input files in a newly allocated meta block, data block, and info block.

11. A method for garbage collection in a flash file system, the method comprising:
(a) reading and storing the contents of a currently used meta block and a data block in a temporary storing place if there exist no more meta blocks and data blocks to be allocated, while a meta block for storing file name information on a file to be stored, file size information, file logic address information, information of whether a meta block is in use or not, and information that the meta block is invalid, and a data block in which contents of a file are actually stored;
(b) deleting invalid contents in a meta block and a data block by reading an info block having information that the meta block is invalid and the data block is no longer effective; and
(c) reading data stored in the temporary storing place and rewriting the data in the deleted meta block and the deleted data block.

12. A recording medium for storing the a computer-readable program for enabling a computer to perform a process of storing files in a flash memory, the process comprising:
(a) receiving a file name of an input file, contents of the input file which will be stored in the flash memory and a file storing command which will be stored in the flash memory;
(b) outputting file management information used in managing the input file, and allocating a meta block for storing the file management information;
(c) storing the file management information in the allocated meta block;
(d) allocating an info block which corresponds to the allocated meta block, the info block for storing data block management information for managing the data block wherein the input contents of the file are stored; and
(e) storing the input contents of the input file in the data block corresponding to the info block.

13. A flash file system management device comprising:
a block searching unit for searching a meta block containing file name information on a file to be stored, file size information, file logical addresses information, information on whether a meta block is in use, and information indicating if a meta block is invalid, and for searching a data block where the contents of a file are to be actually stored;
a block allocation unit for searching and allocating a meta block and a data block which can be used according to the searching results of the searching unit, the searched and allocated meta block corresponding to an info block which stores information of the searched data block;
a reading function performer for searching a meta block where the file name information read in the searching unit is stored, reading an info block corresponding to the meta block, and reading the contents from a physical block where data is actually stored;
a writing function performer for performing write operations of the file to be stored in the meta block, the info block and the data block allocated by the block allocation unit;
a block replacement function performer for exchanging the meta block and the data block where the contents of a file to be corrected are written with a new meta block and a new data block in a case that a file correction command is performed in the write function performer; and
a garbage collection performer for deleting all invalid contents of the meta block, the data block, and the info block, if there does not exist availability to allocate the new meta block and the new data block by the block allocation unit.

14. A flash file system data structure comprising:
a meta block for storing file management information which is information for managing files recorded in a flash memory;
an info block which corresponds to the file management information and stores management information on a block where the contents of a file is stored; and
a data block which corresponds to the management information stored in the info block and stores the contents of the file.

15. The flash file system data structure of claim 14, wherein the file management information comprises file name information on a stored file, file size information, file logic address information, information of whether a meta block is in use, and information indicating if the meta block is invalid.

16. The flash file system data structure of claim 14, wherein the management information comprises information on whether the data block containing the contents of a file is in use, and information indicating that the data block is invalid.
